(19) United States
(12) Patent Application Publication
(10) Pub. No.: US 2019/0311100 A1
(43) Pub. Date: Oct. 10, 2019

(54) SYSTEM AND METHODS FOR SECURING SECURITY PROCESSES WITH BIOMETRIC DATA

(71) Applicants: DYADIC SECURITY LTD, Petach Tikva (IL); Bar-Ilan University, Ramat Gan (IL)

(72) Inventors: Yehuda LINDELL, Givat Shmuel (IL); Guy PE'ER, Talmey Yechiel (IL)

(73) Assignees: Unbound Tech Ltd., Petah Tiqva (IL); Bar-Ilan University, Ramat Gan (IL)

(21) Appl. No.: 16/309,506

(22) PCT Filed: Jun. 14, 2017
(86) PCT No.: PCT/IL2017/050660

§ 371 Date: Dec. 13, 2018

Related U.S. Application Data
(60) Provisional application No. 62/350,216, filed on Jun. 15, 2016.

(51) Int. Cl. G06F 21/32; G06F 21/60; G06F 21/62; G06K 9/00

(52) U.S. Cl. CPC G06F 21/32; G06K 9/00006; G06F 21/62; G06F 21/602

(57) ABSTRACT

The present invention discloses a system and method designed to secure computerized security processes via an MPC based biometric comparison. Such security processes can be operated between a computerized device operated by a user and a third-party server, or a third-party application executed by a computerized device. The MPC based biometric comparison process utilized to secure the security process can be operated by at least one server and in some cases, a computerized device operated by the user. Said servers may operate a Distributed Security Module, (DSM Server), designed to participate in multi-party computation (MPC) processes. The DSM server may be configured to use the MPC based biometric comparison process to compare a biometric data sample provided by the computerized device with a biometric data reference stored in the DSM server.

### FIELD OF THE INVENTION

The invention generally relates to the field of cryptography and security processes, more specifically to use biometric data for controlling the usage of cryptography secrets utilized in security processes taking place between a computerized device and a third-party application or a server.

### BACKGROUND OF THE INVENTION

The extensive use of computers and the continued expansion of telecommunications networks, particularly the internet, enable businesses, governments and individuals to relocate traditional business and administration processes to the internet domain. In some cases, taking these traditional businesses and administrative processes to the internet means to relocate them into a public area and elevate the risk of exposing information to nonauthorized audience. Thus, one of the high prioritized tasks of the people who design these internet services may be to design solutions to secure these services. In many cases, authentication and authorization processes are added to the basic solutions in order to secure the services, the processes and the information thereof. The development of the technology in general and the internet technology in particular shows that the basic authentication and authorization processes do not always meet the requirements of some of the business or governmental processes and services and additional methods to secure the authorization and authentication are needed. In some cases, additional solutions are added to the basic computerized devices in order to raise the security level that these devices support. One of the solutions may be known as a Trusted Platform Module (TPM) designed to secure hardware and software processes by integrating cryptographic keys into the devices. The TPM is an internal solution which secures the computerized device by a secure crypto-processor located within each device. One of the challenges of such internal solutions is that the hardware of every computerized device is required to support such a solution.

### SUMMARY OF THE INVENTION

The present invention discloses a system and method designed to secure computerized security processes via an MPC based biometric comparison. Such security processes can be operated between a computerized device operated by a user and a third-party server, or a third-party application executed by a computerized device. The security processes secured by the subject matter disclosed in the present invention can be in some cases, an authentication or ID verification processes, security processes utilizing cryptographic keys, digital signing processes, data decryption or encryption processes, multi-party authentication processes, and the like. The MPC based biometric comparison process utilized to secure the security process can be operated by at least one server and in some cases, a computerized device operated by the user. Said servers may operate a Distributed Security Module, hereinafter referred to as DSM, designed to participate in multi-party computation (MPC) processes.

The DSM server may be configured to use the MPC based biometric comparison process to compare a biometric data sample provided by the computerized device with a biometric data reference stored in the DSM server. The biometric data reference stored in the DSM server may be provided by the computerized device in advance. For example, in some cases a user may utilize a computerized device to take a biometric data sample, and then send the biometric data sample to be stored in the DSM server (or DSM servers). The biometric data sample received by the computerized device may be stored by the DSM server (or DSM servers) as a biometric data reference which can be compared with other biometric data samples provided by the user. In some cases, the biometric data reference may be split to shares and distributed between a DSM server and the computerized device. In such cases, the MPC process conducted between the DSM server and the computerized device enables performing the biometric comparison without reconstructing the biometric data reference, nor ever bringing the distributed biometric data reference shares together. Utilizing said MPC process can guarantee that the privacy of the biometric samples is preserved.

In possible embodiments of the present invention, the biometric data reference can also be split to more than two shares and distributed in the computerized device and more than one DSM server. In some cases, all the shares of the biometric data reference may be distributed and stored among more than one DSM server, wherein the computerized device may not hold any share of the biometric data reference shares. In such cases, the MPC based comparison process may compare the biometric data reference distributed among the DSM servers and a biometric data sample provided by the computerized device. In possible embodiment of the present invention, the biometric data reference may not be split to shares. In such cases, the biometric data reference may be stored as a whole at the DSM server and the MPC based comparison process may compare a biometric data reference stored in the DSM server and a biometric data sample provided by the computerized device.

The system and method discloses in the present invention can also be configured to control a cryptographic secret which may be used in the security process. The cryptography secrets utilized in the security processes can be private or public keys, symmetric keys, a share or shares of any cryptographic key, hash result, hash function, a decryption or encryption process, and the like. Thus, in case the MPC based comparison process yields a match between the biometric data reference and biometric data sample provided by the computerized device, a second MPC process may take place in order to utilize the cryptography secrets in the security process. In some cases, the cryptography secret may be split and distributed in the DSM server or the DSM servers, and the computerize device. In some other cases, the cryptography secret may be split to shares which may be distributed between more than one DSM server, wherein no share is distributed to the computerized device.

The second MPC process enables to use the cryptography secrets without reconstructing them, nor ever bringing the distributed secret shares together. In some cases, when the MPC based biometric comparison does not yield a match between the biometric data sample provided by the computerized device and biometric data reference, the security process may abort.

In possible embodiments of the present invention, in case the process yields a match between the biometric data sample and the biometric data reference, the system may be configured to manage authorization processes in a selective manner according to the biometric information. Such a selective authorization process may be defined as granting permissions to use/access cryptographic methods, information and the like in some specific security processes

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A discloses a method for generating and storing a biometric data reference wherein the biometric data is split to shares which are distributed among a Distributed Security Module (DSM) server and a computerized device, according to exemplary embodiments of the present invention;

FIG. 1B discloses a method for performing a process denoted as a biometric verification designed to utilize an MPC with at least one DSM server in order to perform a biometric comparison, according to exemplary embodiments of the present invention;

FIG. 2 discloses a method of generating and storing a cryptographic secret of a user, according to exemplary embodiments of the present invention, and;

FIG. 3 discloses a system comprises of a DSM server designed to connect with a computerized device to secure security processes, according to exemplary embodiments of the present invention;

FIG. 4 discloses a method of performing a security process between a computerized device and a third-party server, according to exemplary embodiments of the present invention;

FIG. 5A discloses a method of generating and storing a biometric data reference in a Distributed Security Module (DSM) servers, according to exemplary embodiments of the present invention;

FIG. 5B discloses a method for performing another aspect of the biometric verification wherein the computerized device does not hold any shares of biometric sample, according to exemplary embodiments of the present invention, and;

FIG. 6 discloses a method of performing a security process between a computerized device and a third-party server wherein the computerized device does not hold shares of biometric reference, according to exemplary embodiments of the present invention.

### DETAILED DESCRIPTION OF THE DRAWINGS

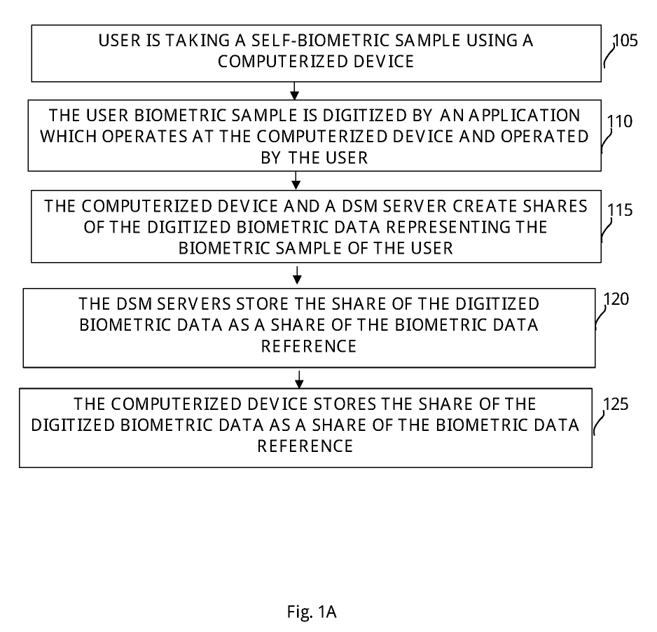

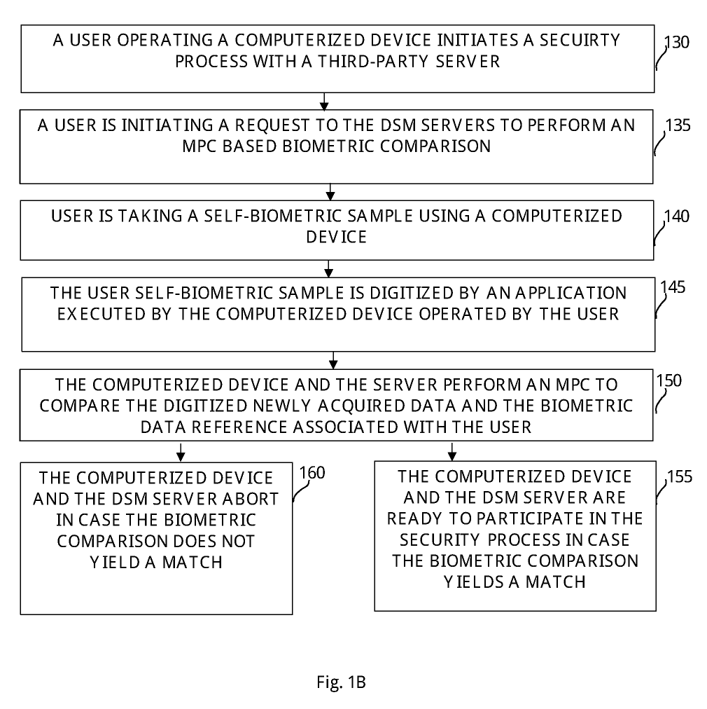

FIG. 1A discloses a method for generating and storing a biometric data reference wherein the biometric data is split to shares which are distributed among a Distributed Security Module (DSM) server and a computerized device, according to exemplary embodiments of the present invention. The generation of the biometric data reference may be performed at the first time the user approaches the DSM servers. After the generation of the biometric data reference, the DSM servers may be able to verify the user's identity in subsequent approaches to said DSM server. In some cases, the DSM servers can be a computerized device such a server, a virtual server, a computerized mobile device, a computerized device capable of executing programmed applications, and the like. For example, a computerized mobile device operated by a user can operate a DSM and participate in multi-party computation (MPC) processes with the computerized device held by the user and utilized for capturing self-biometric data samples.

In step 105 a user operating a computerized device captures a self-biometric data sample. The self-biometric data sample can be taken by any computerized or mechanical device for acquiring biometric data. Such a device can comprise a scanner or a camera and application for face recognition, hand geometry readers, retina scanner, fingerprint scanner, microphone with an application for voice recording, iris scanner, and the like. In step 110, an application operates at the computerized device, receives, and in some cases, digitizes the biometric data sample. Such digitizing process may be performed in order to convert the biometric data of the user into a digital form that can be processed by a computer in MPC based biometric comparison. The digitized biometric data can be in a format of a digital file produced by a computerized device, or a computer file comprises digital representation of sound samples in any media format, or, in some cases a digital video file, digital representation of a signature, digital representation of a scanned fingerprint, or any other digital format used by a person which have ordinary skills in the art to present and store biometric data. In some cases, the computerized device utilized to capture the self-biometric data sample may be a personal device operated by the user, such as a computerized mobile telephone, a personal computer, a computer unit, a tablet personal computer and the like.

Step 115, discloses a process which takes place between the computerized device and a DSM server to generate at least two shares of the biometric sample produced in step 110. In some cases, the process for generating the at least two separate shares may be configured to utilize a Multi-Party Processing (MPC) with the DSM server. In some cases, the MPC may be operated among the computerized device operated by the user and more than one DSM server, for example, two DSM servers, three DSM servers, or multiple DSM servers.

In step 120 the DSM server encrypts and stores the shares of the biometric data of the user, held by the DSM server, as a biometric data reference associated with the user. In possible embodiments of the present invention wherein there are more than one DSM server, other DSM servers may store shares of the biometric data reference and associated the biometric data reference with the user. For example, in case 2 DSM servers are participating in the cryptographic secret generation process, each DSM server can encrypt and store a share of the biometric data reference of the user. Similarly, the computerized device encrypts the share of the biometric data reference of the user sand store in a memory media at the computerized device.

The biometric data reference distributed and stored in the DSM server (or DSM servers) can also be associated with the computerized device operated by the user. For example, the computerized device may comprise a digital certificate utilized to provide a machine identity associated with the computerized device. In step 125 the computerized device also stores the share of the biometric data of the user, held by the computerized device, as a biometric data reference associated with the user. In some cases, once the biometric data reference shares are stored, a process of carrying out a biometric verification may take place (disclosed in FIG. 1B). In such cases, the user may provide a biometric sample and an MPC based comparison process may take place to compare between the newly acquired biometric data and the biometric data reference associated with the user (or in some cases the computerized device), without bringing the shares of the biometric data reference together.

FIG. 1B discloses a method for performing a process denoted as a biometric verification designed to utilize an MPC with at least one DSM server in order to perform a biometric comparison, according to exemplary embodiments of the present invention. In step 130, a user operating a computerized device initiates a security process with a third-party server. In some cases, the third-party server may operate an application or a computer program designed to perform the security process.

In step 135, the computerized device operated by the user may initiate a request to the DSM servers for performing biometric verification in order to be recognized and authorized to perform a security process. It should be noted that the methods disclosed in the subject matter are not limited to sharing the cryptographic key, and only limited to sharing the biometric sample. In some cases, such a request may arrive via communication networks such a LAN, WAN, internet connections, and the like. In some embodiments of the present invention, the request to the DSM servers for performing the biometric comparison may be initiated by the third-party server. In such cases, the third-party sever may send the request to the DSM server and the DSM server may consequently initiate the process of performing the biometric comparison with the computerized device. In possible embodiments of the present invention, the third-party server may send some of the connection details of the computerized device to the DSM server. Such a connection details may be the details required for connecting with the computerized device. For example, in case the computerized device is communicating over communication networks, the connection details may comprise the Internet Protocol (IP) address of the computerized device. In some cases, the connection details may also comprise additional details such as, the Internet Protocol address of a gateway, Internet Protocol address of networking router required for accessing the computerized device, and the like.

In some cases, the DSM server and the third-party sever may hold unique IDs utilized for authentication. For example, the DSM server may hold a unique ID of the third-party server in order to authenticate the third-party and the third-party may hold a unique ID of the DSM server in order to authenticate the third-party sever. Such unique IDs can be tokens, an integer number functioning as a counter, a unique string, and the like.

In step 140 the user operating the computerized device can take a self-biometric data sample as aforementioned. In step 145 an application executed by the computerized device and operated by a user may digitize the newly acquired biometric data sample.

In step 150 the computerized device and the DSM servers, or in some cases a DSM server perform a comparison process based on MPC to compare the data of the newly acquired biometric sample, and the biometric data reference shares associated with the user. For example, in case a XOR operation is used, the DSM server and the computerized device may conduct an MPC based operation that performs a XOR function between the two shares and then operates the matching algorithm between the result and the data of the newly acquired biometric data, without ever reconstructing the biometric data in a single place.

In some cases, the comparison process may be configured to be executed by an MPC between the computerized device operated by the user and the DSM server (or DSM servers), wherein the biometric comparison process utilizes shares of the biometric data reference distributed between the computerized device and a DSM server (or DSM servers). In some cases, the biometric comparison process may be configured to be executed by an MPC between at least two DSM servers, wherein the biometric comparison process utilizes shares of the biometric data reference distributed in at least two DSM servers.

In step 155 the computerized device and the DSM server (or servers) are ready to participate in the security process in case the MPC based biometric comparison yielded a match between the newly acquired biometric data and the distributed biometric data reference. In some cases, such a security process can be an authentication with a third-party server, conducting a digital signing procedure, and the like. In some cases, the MPC is carried out over a secure channel and the security process is carried out over the same channel. For example, in case cryptographic protocols providing communications security over a computer network such as Transport Layer Security (TLS) are used. In other cases, the server can issue a credential to the user (e.g., SAML certificate) attesting to the user identity, for the purpose of authenticating to another server or security process. In some other cases, the security process may require a cryptographic secret held by the DSM server and the computerized device. In such a case, a second MPC process may take place, in order to utilize the cryptographic secret held by the DSM serer and the computerized device (or, DSM servers).

In step 160 in case the MPC based biometric comparison does not yield a match, the biometric verification aborts. For example, in case a user seeking to access a third-party server utilizes an application to provide a fingerprint image via a mobile telephone, the application operating in the mobile telephone digitizes a biometric data sample provided by the user, connects with the DSM server and a MPC based biometric comparison takes place. In case the MPC based biometric comparison fails and there is no match between the biometric data sample provided by the user and the biometric data reference, the security process ends and the user cannot access the third-party server.

The MPC based biometric comparison can be based on diverse techniques. In some cases, such a technique may be through using homomorphic encryption to compare the distance between the newly acquired biometric data and the biometric data reference existing in the system without ever decrypting the biometric data. Another technique which may be used is representing the code comparing the newly acquired biometric data as a Boolean or Arithmetic circuit and using secure computation based on garbled circuits or secure computation based on secret-sharing techniques to perform the comparison.

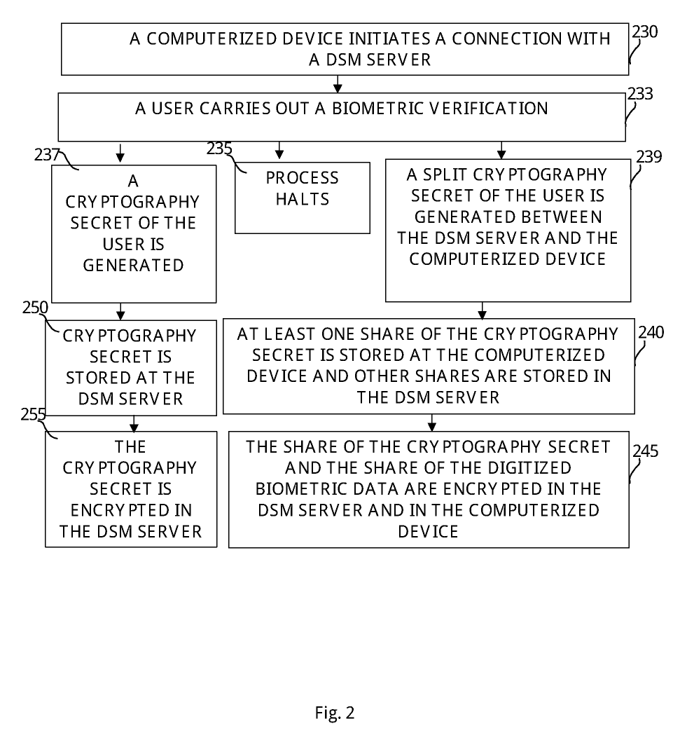

FIG. 2 discloses a method of generating and storing a cryptographic secret of a user, according to exemplary embodiments of the present invention. In some cases, the user operating the computerized device may perform a biometric verification prior the process of generating and storing the cryptographic secret. In step 230 a computerized device operated by a user may initiate a connection with a DSM server (or DSM servers). Such a connection may be via communication networks such a LAN, WAN, internet connections, and the like. In step 233 the user may utilize the computerized device to carry out a biometric verification in order to enable associating the cryptographic secret with a specific biometric data reference stored at the DSM server and at the computerized device. In some cases, the biometric verification may be configured to be executed by an MPC between the computerized device operated by the user and the DSM server (or DSM servers), wherein the biometric verification utilizes shares of the biometric data reference distributed between the computerized device and a DSM server (or DSM servers). In some cases, the biometric verification may be configured to be executed by an MPC between at least two DSM servers, wherein the biometric verification utilizes shares of the biometric data reference distributed in at least two DSM servers.

In step 235 the process halts in case the biometric verification does not yield a match between the newly acquired biometric sample and a biometric data reference.

Step 237 discloses a process which takes place in case the system is configured to store user's cryptographic secret as a whole, in a non-split format. For example, the DSM server can be configured to store the entire cryptographic secret in the DSM server. In some cases, the DSM server may also be configured to present the user's cryptographic secret to a third-party server, in case the biometric verification yielded a match between the user biometric data sample and the biometric data reference. In such cases, the cryptographic secret generated by the computerized device may not be split. In step 250 the cryptographic secret may be stored in the DSM server, and in step 255 the cryptographic secret may be encrypted by the DSM server.

Step 239, discloses a process which takes place in case the system is configured to store a cryptographic secret split to at least two separate shares. In such cases, the computerized device can generate the split cryptographic secret, wherein the cryptographic secret is being generated and split between the DSM server (or servers) and the computerized device operated by the user. The process for generating the cryptographic secret shares may utilize a Multi-Party Computation (MPC) process with the DSM server. In some other cases, other methods or schemes, such as Proactive secret sharing, Shamir's secret-sharing scheme, Blakley's scheme, and the like may be used for splitting the cryptographic secret to cryptographic secret shares. In some cases, in which more than one DSM server is participating at the cryptographic secret generation process, the cryptographic secret may be split to multiple shares and then stored in multiple DSM servers.

Step 240 takes place in case the cryptographic secret is split to more than one share. In such cases, one cryptographic secret share can be stored in the computerized device, and another cryptographic secret share can be stored in a DSM server. In some cases, the cryptographic secret share may be associated, by the DSM server, with a user ID. In some cases, the computerized device may also associate the cryptographic secret share with the user ID. The user ID can be a unique name, a unique sequence of characters used to identify a user and utilized to associate the user operating the computerized device with the biometric data reference. In some cases, the user ID can be a digital certificate, a secret key, a digital file, a token, and the like.

The cryptographic secret can be selected from a group comprising cryptographic keys (RSA), a one-time password (OTP) seed and the like. In some cases, in which more than one DSM server is participating in the cryptographic secret splitting process, some shares may be stored in the other DSM servers. In step 245 the DSM server encrypts the share of the cryptographic secret. In some cases, in which more than one DSM server is participating in the cryptographic secret splitting process, other DSM servers may also encrypt the cryptographic secrets. In possible embodiments of the present invention, the DSM server may associate the biometric data reference with the encrypted share of the cryptographic secret generated in step 239 or 237.

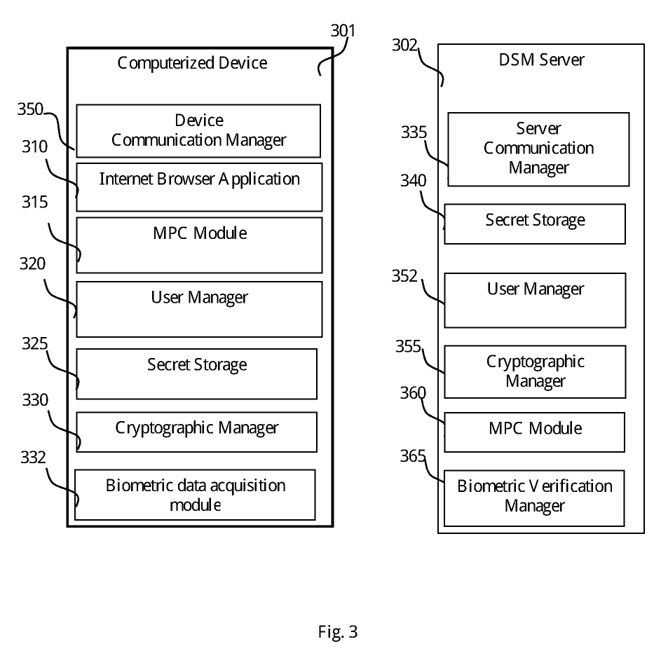

FIG. 3 discloses a system comprises of a DSM server designed connect with a computerized device to secure security processes, according to exemplary embodiments of the present invention. FIG. 3 shows a system comprises a DSM server 302 designed to connect with computerized device 301 to secure the security processes which take place between the computerized device 301 and a third-party server. The DSM server 302 comprises a Server Communication Manager 335 which manages the communication with the DSM server 302 over communication networks such as internet networks local area networks, wide area networks and the like. The DSM server 302 also comprises a Secret Storage 340 for storing secretes such as cryptographic secrets utilized for the security processes, and the shares of the biometric data references. The DSM server 302 also comprises a User Manager 352 which in some cases can be configured to associate the biometric data reference and the cryptographic secrets with the users utilizing the computerized device. In some cases, the User Manager 352 may also comprise a list of services or servers associated with the users, for the purpose of managing authorization processes with third-party services. For example, a certain user may be eligible to connect to some specific services and not be eligible to connect to other specific services. In some cases, a user may be eligible to connect some specific services of one third-party service provider and not be eligible to connect to some other specific services of the same third-party service provider. For example, a user providing biometric credentials may be eligible to utilize secret keys for preforming an authentication process with a third-party server and may be not eligible to utilize said secret key for digital signing on a document provided by the same third-party server.

DSM server 302 also comprises a Cryptographic Manager 355 designed to perform tasks and processes related to cryptography such as generating keys, decrypt and encrypt data associated with the users and the like. DSM server 302 also comprises a MPC Module 360 designed to manage the multi-party computing process as described above. In some embodiments of the present invention the DSM server 302 may be implemented on a personal computer or in some cases on a computerized device capable of operating the MPC Module 360. Such a computerized device may also comprise the Server Communication Manager 335, Secret Storage 340, User Manager 352, and the Cryptographic Manager 355.

In some cases, the DSM server 302 may also comprise a Biometric Verification Manager 365 designed to manage the type of the biometric specific verification required for the biometric data references. For example, in case a user connects to the DSM server at the first time, by a computerized device, the Biometric Verification Manager 365 may configure the biometric verification type. The types of the biometric verification can be at least one type of the following group: (i) Biometric verification wherein the biometric data reference is split to shares and the shares are shared between the DSM server 302 and the computerized device 301. (ii) Biometric verification wherein the biometric data reference is split to shares and the shares are shared between more than one DSM server, similar to DSM server 302, and the computerized device 301. (iii) Biometric verification wherein the biometric data reference is split to shares and the shares are shared between more than one DSM server similar to DSM server 302, wherein the computerized device 301 does not hold any share of the biometric data reference. (iv) Biometric verification wherein the biometric data reference is not split to shares, and the biometric data reference is stored in the DSM server 302 as a whole in a non-split format.

The security process disclosed herein refers to an exemplary case in which both a biometric sample and a secret (for example a security key) are shared and the biometric verification performed using MPC process leads to an MPC process for verifying the secret. It should be noted that the subject matter also discloses a case in which the key is not shared, and only the biometric sample is shared and then compared with a biometric data reference, without bringing the biometric sample shares together. It should be also noted that the subject matter also discloses a case in which the biometric data reference is not split, and kept as a whole, by the DSM server. In such cases, the DSM server may require to perform an MPC to for the biometric verification. In some other cases the biometric data reference may be split and shared between the DSM servers only.

The DSM server 302 can connect with a Computerized Device 301 operated by a user and preforms the security process which utilizes a cryptographic secret. The Computerized Device 301 is also utilized in other operations of the user such as operating private applications, connecting to the internet, sharing personal information with other users using mobile devices or computers, and the like. The Computerized Device 301 comprises a Device Communication Manager 350 which manages the communication of the Computerized Device 301 over communication networks. Such communication networks may be radio frequency (RF) based communication also known in the industry as Wi-Fi, wired based communications to the internet, and the like. The Computerized Device 301 also comprises Internet Browser Application 310 for browsing the internet. The browser 310 can be any standard and commercial product for connecting to the internet or any designated software designed for a specific application of the internet, such as a news/finance mobile application. The Computerized Device 301 also comprises an MPC Module 315 designed to manage the multi-party computation process as described above.

The Computerized Device 301 also comprises User Manager 320 that associates the shares of the biometric data reference with the users utilizing the computerized device 301. In some cases, the shares of the biometric data reference may be associated with the user ID. For example, a user operating the Computerized Device 301 acquires a new biometric sample such as fingerprint image. The new biometric sample is converted to a digital file and then, split to at least two shares. The share stored by the Computerized Device 301 can be listed and associated with the user ID by the User Manager 320. In some cases, the User manager 320 may also list multiple cryptographic secrets as described in FIG. 2 and associate the listed cryptographic secrets with the user ID. The Computerized Device 301 also comprises a Secret Storage 325 for storing secretes such as shares of the cryptographic secrets utilized for the security processes, and the shares of the biometric data references. In some cases, the Secret Storage 325 may also be configured to associate the shares of the cryptographic secrets with the shares of the biometric data reference. For example, in case a user is required to utilize a specific encryption key in a security process, the Computerized Device 301 may identify the biometric data reference associated with said specific encryption key, and utilize the biometric data reference to perform a MPC based biometric comparison with the DSM server. Then, in case the MPC based biometric comparison yields a match and the user is recognized as eligible to utilize said encryption key, a second MPC process can take place between the DSM server and the computerized device in order to utilize the encryption key. Once the second MPC is completed, the encryption key can be utilized by the Computerized Device 301 for the security process.

The Computerized Device 301 also comprises a Cryptographic Manager 330 designed to perform tasks and processes related to cryptography. For example, in case a biometric data is received and required to be digitized, the Cryptographic Manager 330 conducts the digitization process and converts the biometric data into a digital representation of the biometric data. The Cryptographic Manager 330 can also be configured to conduct the secret splitting process in order to split digital strings to multiple shares. For example, in case an MPC process is conducted by the MPC Module 315 to split a digital string to multiple shares, the Cryptographic Manager 330 preforms the secret splitting process according to instruction received from the MPC Module 315.

The Computerized Device 301 also comprises a Biometric data acquisition module 332 configured to enable the user to input biometric data into the Computerized Device 301. Such acquisition module 332 may be a camera, a pad, a scanner, and the like, to which the user can input biometric data into the Computerized Device 301. In some cases, the acquisition module 332 may be a communication port from another electronic device, for example a USB memory device.

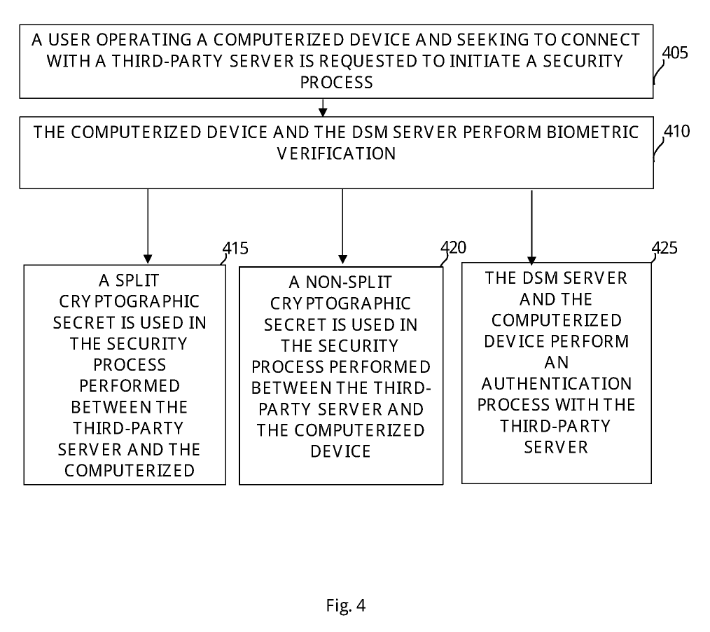

FIG. 4 discloses a method of performing a security process between a computerized device and a third-party server, according to exemplary embodiments of the present invention. In step 405 a user operating a computerized device seeking to connect with a third-party server may be requested to initiate a security process. In some cases, such a request may be conducted by an application operated at the computerized device. Such an application may be a dedicated application designed to connect to said third-party server, or a general application designed to utilize internet technology such as internet browser application and connect to third party servers. In step 410 the computerized device and the server perform a biometric verification. In some cases, the request to perform the biometric verification may be initiated by the computerized device, or by an application operated in the computerized device. In some other cases, the request to perform the biometric verification may be initiated by the third-party server which may send the request to the DSM server (or DSM serves) and the DSM server may consequently send the computerized device a request to initiate the biometric verification.

Step 415 takes place in case the biometric verification yields a match, and in case a split cryptographic secret is used in the security process. In some cases, the cryptographic secret may be split and distributed between the computerized device and the DSM server. In such cases, the computerized device and the DSM server can be configured to perform an MPC process, denoted as second MPC process, in order to utilize the cryptographic secret in the security process. For example, in case a private key based authentication process is requested by the third-party application or a service, the second MPC may utilize the private key for the authentication process out of the private key shares distributed in the DSM servers and the computerized device. Another example may be with a digital signing process in which the key used for signing is split between the computerized device and the DSM server. Thus, the DSM server and the computerized device may perform the second MPC to utilize the key used for signing out of the key shares distributed in the DSM servers and the computerized device. In some cases, the cryptographic secret may be for generating a one-time password, signature, decrypted information and the like.

Step 420 takes place in case the biometric verification yields a match, and a non-split cryptographic secret is used in the security process. For example, the DSM server can be configured to store the entire cryptographic secret in a non-split format and utilize the non-split cryptographic secret in the security process. In some cases, the DSM server may be also configured to present the user's cryptographic secret to the third-party server.

Step 425 takes place in case the biometric verification yields a match, and in case the security process takes place without additional cryptographic secrets, such as private keys, public keys, encryption keys, digital signatures, and the like. For example, in some cases, the biometric verification may be utilized to verify the eligibility of a user to connect to a third-party server such as an authentication server. Such cases can be wherein the DSM server issues a credential like a SAML certificate to the user. In such case, the user can then send the certificate to the authentication server who verifies the certificate and allows the user to connect in case the certificate is valid.

In some cases, the DSM server and the computerized device may be configured to provide authorization functionality. For example, the system may approve the user ID and grant permission to utilize the user's private key to perform an authentication process and deny the permissions of using the user's private key to conduct an encryption process. In some cases, the security process with a third-party application may be an authorization process. Thus, the system may be configured to manage authorization processes in a selective manner according to the biometric information. Such selective authorization may be defined as granting permissions to use/access cryptographic methods, information and the like in some specific security processes. For example, a user providing biometric credentials may be allowed to use the private key to conduct an authentication process with a third-party server and may be refused to utilize the private key for other purposes such as digital signing, encryption processes, decryption process and the like.

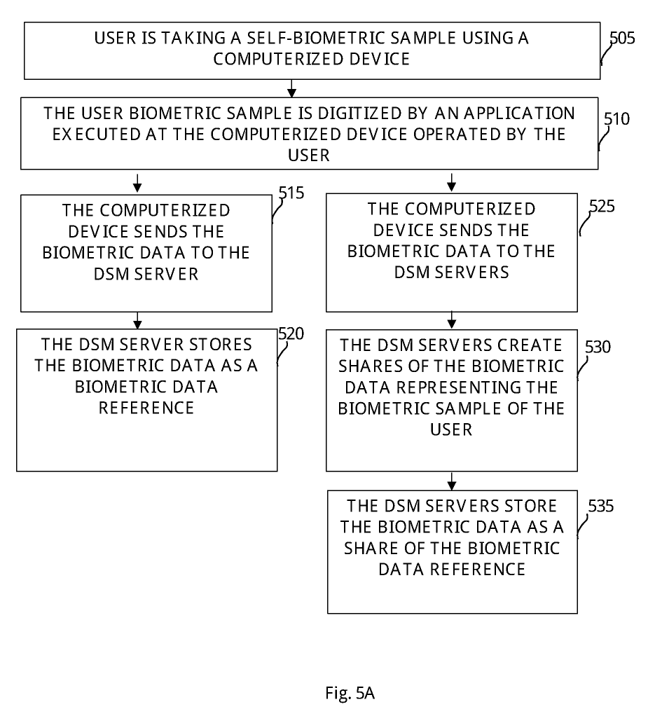

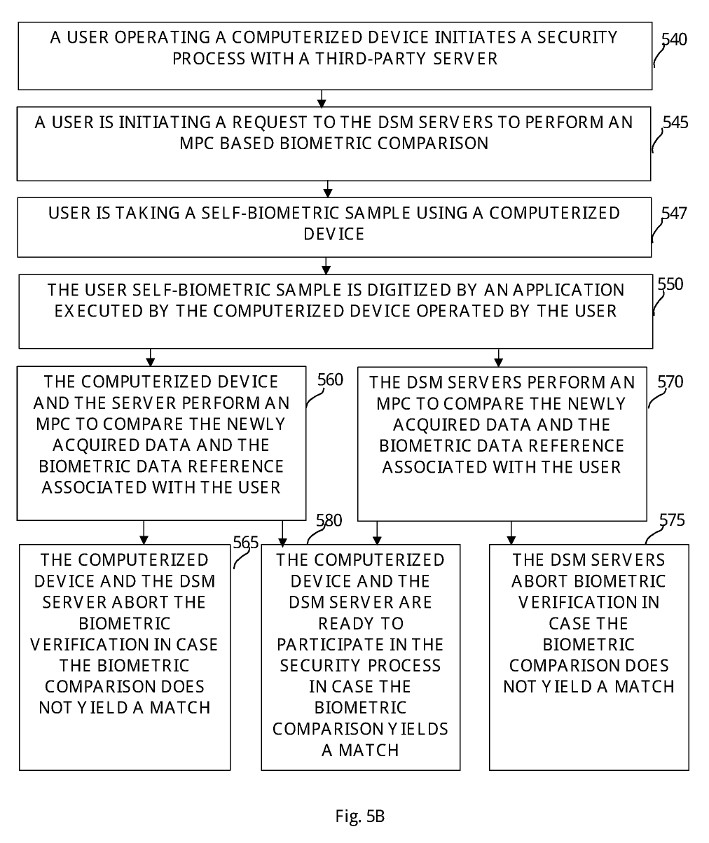

FIG. 5A discloses a method of generating and storing a biometric data reference in a Distributed Security Module (DSM) servers, according to exemplary embodiments of the present invention. The generation of the biometric data reference may be performed at the first time the user approaches the DSM servers. In some cases, after the generation of the biometric data reference, the DSM servers may be able to verify the user's identity in subsequent approaches to said DSM server.

In step 505 a user operating a computerized device captures a self-biometric data sample. The self-biometric data sample can be taken by any computerized or mechanical device for acquiring biometric data. Such a device can comprise a scanner or a camera and application for face recognition, hand geometry readers, retina scanner, fingerprint scanner, microphone with an application for voice recording, iris scanner, and the like. In step 510, an application operated by the computerized device receives, and in some cases, digitizes the biometric data sample. Step 515 discloses an optional configuration of the DSM server which implements one aspect of the present invention in which the computerized device sends a non-split biometric sample as a whole to the to the DSM server. In step 520 the DSM server may store the non-split biometric sample as a biometric data reference, and in some cases, the DSM server may encrypt the biometric data reference.

Step 525 discloses an optional configuration of the DSM server which implements another aspect of the present invention in which the computerized device sends the complete biometric sample to at least two DSM servers. In step 530 the DSM servers which receive the biometric sample, can operate a process for generating the at least two shares of the received biometric sample. In some cases, the DSM servers may be configured to utilize a Multi-Party Processing (MPC) operated among the DSM servers for creating the shares. In some other cases, the process for generating the at least two shares of the biometric sample may utilize other methods which are known to a person who has ordinary skills in the art. In some embodiments of the present invention the computerized device operated by the user may be configured to generate the biometric sample shares and then send them to the DSM server. In such cases, the computerized device may be configured to utilize methods for splitting the biometric sample to shares which are known to a person who has ordinary skills in the art

In step 535 the DSM servers may store the shares of the biometric sample as a biometric data reference, and in some cases, may also encrypt the biometric data reference. In some cases, the DSM servers may be configured to associate the biometric data reference with the user. In some other cases, the DSM servers may associate the biometric data reference with the computerized device which sent the biometric sample. In some cases, once the shares of the biometric data reference are stored, a biometric verification may take place (disclosed in FIG. 5B). In such cases, the user may provide a biometric sample and an MPC based comparison process may take place to compare between the newly provided biometric data sample and the biometric data reference associated with the user (or in some cases the computerized device), without bringing the shares of the biometric data reference together.

FIG. 5B discloses a method for performing another aspect of the biometric verification wherein the computerized device does not hold any shares of biometric sample, according to exemplary embodiments of the present invention. In step 540, a user operating a computerized device initiates a security process with a third-party server. In some cases, the third-party server may operate an application or a computer program designed to perform the security process.

In step 545, the computerized device operated by the user may initiate a request to the DSM servers for performing biometric verification in order to be recognized and authorized to perform a security process. In some cases, such a request may arrive via communication networks such a LAN, WAN, internet connections, and the like. In some embodiments of the present invention, the request to the DSM servers for performing the biometric comparison may be initiated by the third-party server. In such cases, the third-party server may send the request to the DSM server and the DSM server may consequently initiate the process of performing the biometric comparison with the computerized device. In possible embodiments of the present invention, the third-party may send to the DSM server some of the connection details of the computerized device. Such a connection details may be the details required for connecting with the computerized device. For example, in case the computerized device is communicating over communication networks, the connection details may comprise the Internet Protocol (IP) address of the computerized device. In some cases, the connection details may also comprise additional details such as, the Internet Protocol address of a gateway, Internet Protocol address of networking router required for accessing the computerized device, and the like.

In some cases, the DSM server and the third-party sever may hold unique IDs utilized for authentication. For example, the DSM server may hold a unique ID of the third-party server in order to authenticate the third-party and the third-party may hold a unique ID of the DSM server in order to authenticate the third-party sever. Such unique IDs can be tokens, an integer number functioning as a counter, a unique string, and the like. In step 547 the user operating the computerized device can take a self-biometric data sample as aforementioned. In step 550 an application executed by the computerized device and operated by a user may digitize the newly acquired biometric data sample.

Step 560 discloses a comparison process based on MPC which compares the newly acquired biometric sample, and the biometric data reference shares associated with the user. The process disclosed in step 560 takes place in case the biometric data reference is not split. In such cases, the DSM server may hold the complete biometric data references associated with the user or with the computerized device. The DSM server and the computerized device may conduct an MPC based operation that operates the matching algorithm between the result and the newly acquired biometric data. In step 565, in case the MPC based biometric comparison does not yield a match, the biometric verification aborts. Step 570 discloses an MPC based comparison process wherein the biometric data reference is split to shares which are stored in at least two DSM servers. Step 570 shows the process designed to take place in case the computerized device operated by the user does not hold any share of the biometric data reference.

In step 575 the DSM server aborts the biometric verification in case the biometric comparison process does not yield a match between the newly acquired sample and the biometric data reference. In step 580 the computerized device and the DSM server (or servers) are ready to participate in the security process in case the MPC based biometric comparison yields a match between the newly acquired biometric data and the distributed biometric data reference. In some cases, such a security process can be an authentication with a third-party server, conducting a digital signing procedure, and the like. In some cases, the MPC is carried out over a secure channel and the security process is carried out over the same channel. For example, in case cryptographic protocols providing communications security over a computer network such as Transport Layer Security (TLS) are used. In other cases, the server can issue a credential to the user (e.g., SAML certificate) attesting to its identity, for the purpose of authenticating to another server or security process. In some cases, the security process may require a cryptographic secret held by the DSM server and the computerized device. In such a case, a second MPC process may take place, in order to utilize the cryptographic secret held by the DSM serer and the computerized device (or, DSM servers).

The MPC based biometric comparison can be based on diverse techniques. In some cases, such a technique may be through using homomorphic encryption to compare the distance between the newly acquired biometric data and the biometric data reference existing in the system without ever decrypting the biometric data. Another technique which may be used is representing the code comparing the newly acquired biometric data as a Boolean or Arithmetic circuit and using secure computation based on garbled circuits or secure computation based on secret-sharing techniques to perform the comparison.

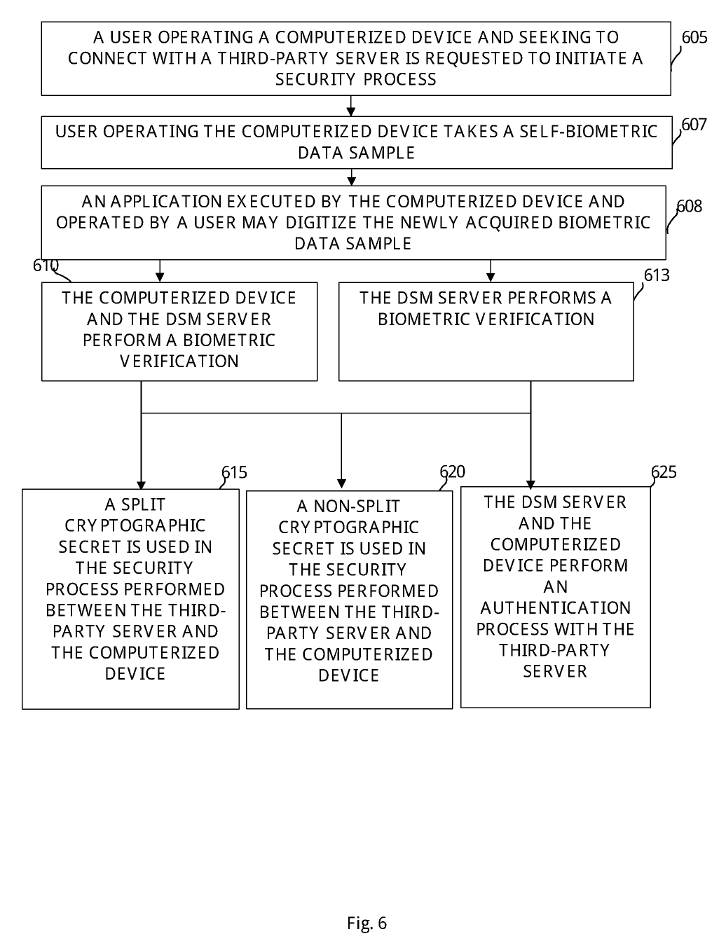

FIG. 6 discloses a method of performing a security process between a computerized device and a third-party server wherein the computerized device does not hold shares of the biometric reference, according to exemplary embodiments of the present invention. In step 605 a user operating a computerized device seeking to connect with a third-party server may be requested to initiate a security process. In some cases, such a request may be conducted by an application operated at the computerized device. Such an application may be a dedicated application designed to connect to said third-party server, or a general application designed to utilize internet technology such as internet browser application and connect to third party servers. In Step 607, the user operating the computerized device can take a self-biometric data sample as aforementioned. In step 608 an application executed by the computerized device and operated by a user may digitize the newly acquired biometric data sample. Step 610 discloses an optional configuration of the DSM server which implements one aspect of the present invention in which the biometric verification takes place wherein the computerized device does not hold any shares of biometric reference and the MPC takes place between the computerized device holding the biometric sample and the DSM server holding the biometric reference. In some cases, the request to perform the biometric verification wherein the computerized device does not hold shares of biometric reference may be initiated by the computerized device, or by an application operated in the computerized device. In some other cases, the request to perform the biometric verification wherein the computerized device does not hold shares of biometric sample, may be initiated by the third-party server which may send the request to the DSM server (or DSM serves) and the DSM server may consequently send the computerized device a request to initiate the biometric verification wherein the computerized device does not hold shares of biometric sample.

Step 613 discloses an optional configuration of the DSM server which implements one aspect of the present invention in which the MPC of the biometric verification involves the computerized device and the DSM servers, in an MPC based comparison process wherein the biometric data reference stored in at least two DSM servers as disclosed in step 570.

Step 615 takes place in case the biometric verification yields a match and in case a split cryptographic secret is required to be used in the security process performed between the third-party server and the computerized device. In some cases, cryptographic secret may be split and distributed between the computerized device and the DSM server. The computerized device and the DSM server may be configured to perform an MPC process, denoted as second MPC process, in order to provide the cryptographic secret to the third-party server. For example, in case a private key based authentication process is requested by the third-party application or a service, the second MPC may utilize the private key for the authentication process out of the private key shares distributed in the DSM servers and the computerized device. Another example may be with a digital signing process in which the key used for signing is split between the computerized device and the DSM server. Thus, the DSM server and the computerized device may perform the second MPC to utilize the key used for signing out of the key shares distributed in the DSM servers and the computerized device. In some cases, the cryptographic secret may be for generating a one-time password, signature, decrypted information and the like.

Step 620 takes place in case the biometric verification yields a match, and in case a non-split cryptographic secret is used in the security process performed between the third-party server and the computerized device. In such a case, the DSM server may present the cryptographic key to the third-party server. The security process which takes place in case the system is configured to store user's cryptographic secret as whole, in a non-split format. For example, the DSM server can be configured to store the entire cryptographic secret, in a non-split format at the DSM server. In some cases, the DSM server may be also configured to present the user's cryptographic secret to a third-party server.

Step 625 takes place in case the biometric verification yields a match, and in case the security process takes place without additional cryptographic secrets, such as private keys, public keys, encryption keys, digital signatures, and the like. For example, in some cases, the biometric verification may be utilized to verify the eligibility of a user to connect, such that in case the biometric verification yields a match between the biometric sample of the user and a biometric data reference, the user may be allowed to connect to a third-party server such as an authentication server. For example, in case the DSM server issues a credential like a SAML certificate to the user. In such case, the user can then send the certificate to the authentication server who verifies the certificate and allows the user to connect in case the certificate is valid.

In some cases, the DSM server and the computerized device may be configured to provide authorization functionality. For example, the system may approve the user ID and grant permission to utilize the user's private key to perform an authentication process and deny the permissions of using the user's private key to conduct an encryption process. In some cases, the security process with a third-party application may be an authorization process. Thus, the system may be configured to manage authorization processes in a selective manner according to the biometric information. Such selective authorization may be defined as granting permissions to use/access cryptographic methods, information and the like in some specific security processes. For example, a user providing biometric credentials may be allowed to use the private key to conduct an authentication process with a third-party server and may be refused to utilize the private key for other purposes such as digital signing, encryption processes, decryption process and the like.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method for conducting security processes between a computerized device and a third-party server, comprising:
receiving a request, by a at least one Distributed Security Module (DSM) server, to compare a biometric sample of a user with a biometric data reference split to shares, wherein said shares are distributed and stored in the computerized device and in the at least one DSM server;
performing a comparison process between the biometric sample of the user provided by the computerized device and the biometric data reference using a Multi-Party Computation (MPC) process between the computerized device and the at least one DSM server;
performing a security process between the computerized device and DSM server, and the third-party server in case the comparing of the biometric sample of the user provided by the computerized device with the split biometric data reference yields a match.

2. The method of claim 1, wherein the request to compare the biometric sample of the user with the biometric data reference split to shares is received from the third-party server.

3. The method of claim 1, wherein the request to compare the biometric sample of the user with the biometric data reference split to shares is received from the computerized device.

4. The method of claim 1, wherein the security process between the computerized device and DSM server further requires a cryptography secret.

5. The method of claim 4, wherein the cryptography secret is stored in the at least one DSM server.

6. The method of claim 5, wherein the cryptography secret stored in the at least one DSM server is encrypted.

7. The method of claim 4, wherein the cryptography secret is split to more than one cryptography secret share.

8. The method of claim 7, wherein at least one of the cryptography secret shares is stored in the at least one DSM server.

9. The method of claim 8, wherein the at least one of the cryptography secret shares stored in the at least one DSM server is encrypted.

10. The method of claim 7, wherein at least one of the cryptography secret shares is stored in the computerized device.

11. The method of claim 10, wherein at least one of the cryptography secret shares stored in the computerized device is encrypted.

12. The method of claim 7, further comprises the computerized device and the at least one DSM server preforming another MPC process for utilizing the cryptography secret in a security process with the third-party.

13. The method of claim 1, further comprises capturing the biometric sample by the computerized device.

14. The method of claim 1, wherein the security process aborts in case there is no match between the biometric data reference and the biometric sample captured from the user and provided by said computerized device,

15. The method of claim 1, wherein the biometric data reference is associated with said user.

16. The method of claim 1, further comprises an enrollment phase between the computerized device and the least one DSM server, wherein the enrollment process comprises creating a biometric data reference split to shares and distributing between the computerized device and the least one DSM server.

17. The method of claim 16, wherein the enrollment phase further comprises storing at least one share of the biometric data reference shares in the least one DSM server.

18. The method of claim 16, wherein the enrollment phase further comprises storing one share of the biometric data reference shares in the computerized device.

19. The method of claim 16, wherein the enrollment phase further comprises encryption of at least one share of the biometric data reference shares stored in the least one DSM server.

20. The method of claim 16, wherein the enrollment phase further comprises encryption of the share of the biometric data reference shares stored in the computerized device.

21. The method of claim 1, wherein all the shares of the split biometric data reference are distributed and stored in more than one DSM server.

22. The method of claim 21, wherein the shares of the split biometric data reference are utilized in an MPC process which compares the shares of biometric data reference distributed and stored in more than one DSM server, with a biometric data sample of a user provided by the computerized device.

23. The method of claim 1, wherein the biometric data reference is stored as a whole in a DSM server.

24. The method of claim 23, wherein the biometric data reference stored as a whole in a DSM server is utilized in an MPC process which compares the biometric data reference with a biometric data sample provided by the computerized device.

25. A system for conducting security processes between a computerized device and a third-party server, comprising:
at least one DSM server configured to receive a request to compare a biometric sample of a user with a biometric data reference split to shares, wherein said shares are distributed and stored in the computerized device and in the at least one DSM server;
at least one secret storage located at the at least one DSM server designed to store shares of biometric data references;
at least one MPC module located at the at least one DSM server designed to perform an MPC comparison process with said computerized device to compare a biometric sample of a user with biometric data reference split to shares, wherein the biometric sample is provided by said computerized device;
and wherein the at least one DSM server is further configured to perform a security process between the computerized device and at least one DSM server, and the third-party server in case the MPC comparison process between the biometric sample of a user and the split biometric data reference, yields a match.

26. The system of claim 25, further comprises a user manager to associate the users with the biometric data references.

27. The system of claim 25, further comprises a second MPC module to perform an MPC process between the at least one DSM server and the computerized device.

28. The system of claim 25, wherein the computerized device further comprises a device for capturing a biometric data from a user.

29. The system of claim 25, wherein said shares of biometric data references are associated with users utilizing the computerized device.
